(19) United States
(12) Patent Application Publication
(10) Pub. No.: US 2022/0306953 A1
(43) Pub. Date: Sep. 29, 2022

(54) Premixing Apparatus

(71) Applicant: RINNAI CORPORATION, Aichi (JP)

(72) Inventor: Katsuya Noritake, Aichi (JP)

(73) Assignee: RINNAI CORPORATION, Aichi (JP)

(21) Appl. No.: 17/592,855

(22) Filed: Feb. 4, 2022

(30) Foreign Application Priority Data
Mar. 23, 2021 (JP) 2021-048198

(51) Int. Cl. C10K 3/06; B01F 23/10; B01F 35/71

(52) U.S. Cl. CPC C10K 3/06; B01F 23/191; B01F 35/718051; B01F 2101/501

(57) ABSTRACT

A premixing apparatus has a butterfly valve provided in an air supply passage, a zero governor and a variable throttle valve interposed in a gas supply passage. A control is performed to switch a combustion capacity between at least two stages of a large-capacity stage and a small-capacity stage through change in opening degrees of the butterfly valve and the variable throttle valve. At the small-capacity time, in case the opening degree of the variable throttle valve, when regulated so that the λ becomes a predetermined value, has been changed more to the small-opening-degree side than the predetermined small-capacity opening degree, in a state in which the opening degree of the variable throttle valve has been returned to the predetermined small-capacity opening degree, the opening degree of the butterfly valve is regulated such that the λ becomes the predetermined value, and the small-capacity opening degree of the butterfly valve is renewed to the predetermined value when the λ becomes the predetermined value.

### TECHNICAL FIELD

The present invention relates to a premixing apparatus for mixing air with a fuel gas in order to supply a burner with an air fuel mixture via a fan.

### BACKGROUND ART

Conventionally, as this kind of premixing apparatus, there is known one in which a zero governor for controlling a secondary gas pressure to atmospheric pressure is interposed in a gas supply passage whose downstream end is connected to a gas suction part which is disposed in an air supply passage on an upstream side of the fan. The supply amount of a fuel gas varies with a differential pressure between the atmospheric pressure, which is the secondary gas pressure, and a negative pressure in the air supply passage. Since the negative pressure in the air supply passage varies with the rotational speed of the fan, the supply amount of the fuel gas varies with the rotational speed of the fan, i.e., varies in proportion to the supply amount of the air. Therefore, by controlling the rotational speed of the fan depending on the required combustion amount, the amount of the air-fuel mixture according to the required combustion amount is supplied to the burner and the excess air ratio (amount of primary air/ amount of air in theoretical air-fuel ratio) becomes constant.

By the way, there are cases where the calorific value (Wobbe Index) of the fuel gas may fluctuate with the time of the day even if the same kind of gas is being used as the fuel gas. In the above-mentioned conventional example, even if the calorific value of the fuel gas may fluctuate, the ratio of the supply amount of air to the supply amount of the fuel gas remains constant. Therefore, accompanied by the fluctuation of the calorific value of the fuel gas, the excess air ratio of the air-fuel mixture may fluctuate, thereby resulting in poor combustion.

Under the circumstances, there is conventionally known in patent document 1 also a premixing apparatus which is provided with: a variable throttle valve interposed in a portion, on a downstream side of a zero governor, of a gas supply passage; an excess air ratio detecting device for detecting the excess air ratio of the air-fuel mixture; and a control device. The control device is arranged to perform the control of an opening degree of the variable throttle valve such that the excess air ratio of the air-fuel mixture as detected by the excess air ratio detecting device becomes a predetermined value. According to this arrangement, even if the calorific value of the fuel gas may fluctuate, by the control of the variable throttle valve the excess air ratio of the air-fuel mixture can be maintained constant, thereby preventing the poor combustion from occurring.

In addition, in the premixing apparatus as described in patent document 1, a butterfly valve is interposed in a portion, on an upstream side of the gas suction part, of the air supply passage. In this arrangement, control is performed to switch a combustion capacity between at least two stages of a large-capacity stage and a small-capacity stage through changes in opening degrees of the butterfly valve and of the variable throttle valve. In other words, when the required combustion amount is relatively small, the opening degree of the butterfly valve is made to be a predetermined closing-side small-capacity opening degree, and the opening degree of the variable throttle valve is made to be a predetermined small-capacity opening degree that is smaller than the reference opening degree. According to the above-mentioned arrangement, the combustion capacity is switched to the small capacity so that there can be supplied to the burner the air-fuel mixture whose air-fuel excess air ratio is of an appropriate value and in an amount corresponding to the relatively small required combustion amount. In addition, when the required combustion amount is relatively large, the opening degree of the butterfly valve is made to be the predetermined opening-side large-capacity opening degree, and also the opening degree of the variable throttle valve is made to be the large-capacity opening degree that is the reference opening degree. According to the above-mentioned arrangement, the combustion capacity is switched to the large capacity so that there can be supplied to the burner the air-fuel mixture whose excess air ratio is of the appropriate value and in an amount corresponding to the relatively large required combustion amount.

As a result, the relationship between the rotational speed of the fan and the supply amount of the air-fuel mixture, i.e., the combustion amount of the burner is as represented by a characteristic line L in FIG. 6 in case of the small capacity and as represented by a characteristic line H in FIG. 6 in case of the large capacity. The maximum combustion amount QLmax in the small capacity is set to be slightly larger than the minimum combustion amount QHmin in the large capacity. It is thus so arranged that the range of combustion amount obtainable in the small capacity and the range of combustion amount obtainable in the large capacity partly overlap with each other.

By the way, if foreign matters get adhered to a wall surface of a portion, at which the butterfly valve is disposed, of the air supply passage, and when the amount of adhesion of the foreign matters increases with the lapse of time, the amount of air to pass through decreases at the small-capacity time, and the excess air ratio decreases. According to the arrangement as described in patent document 1, the opening degree of the variable throttle valve is regulated so that the excess air ratio of the air-fuel mixture, as detected by an excess air ratio detecting device, becomes a predetermined value. Therefore, at the small-capacity time, if the amount of air to pass through decreases with a consequent decrease in the excess air ratio, the opening degree of the variable throttle valve, after having been regulated, will change more to the small-opening-degree side than the predetermined small-capacity opening degree. As a result, the characteristic line of fan rotational speed—combustion amount at the small-capacity time changes to the low-combustion amount side as shown by L′ in FIG. 6. Accordingly, the maximum combustion amount QL′max in the small capacity becomes smaller than the minimum combustion amount QHmin in the large capacity, and thus the range of combustion amount obtainable in the small capacity and the range of combustion amount obtainable in the large capacity do not overlap with each other any longer. It follows that the combustion amount within this range of non-overlapping cannot be obtained any longer.

### PRIOR ART DOCUMENT

### Patent Document

Patent Document: JP-A-2021-25722

### SUMMARY OF THE INVENTION

### Problems that the Invention is to Solve

In view of the above points, this invention has a problem of providing a premixing apparatus which is arranged to keep a fan rotational speed—combustion amount characteristic line at a small-capacity time as it was originally the case and in which the range of combustion amount obtainable in the small capacity and the range of combustion amount obtainable in the large capacity can be prevented from ceasing to overlap with each other, even if foreign matters get adhered and deposited on the wall surface of the air supply passage which has disposed therein a butterfly valve.

### Means of Solving the Problems

In order to solve the above problem, this invention is a premixing apparatus for mixing air with a fuel gas to supply a burner with an air-fuel mixture through a fan. The premixing apparatus includes: a zero governor for regulating a secondary gas pressure to an atmospheric pressure, the zero governor being interposed in a gas supply passage whose downstream end is connected to a gas suction part disposed in an air supply passage on an upstream side of the fan; a variable throttle valve interposed in a portion, on a downstream side of the zero governor, of the gas supply passage; a butterfly valve interposed in a portion, on an upstream side of the gas suction part, of the air supply passage; an excess air ratio detecting device for detecting an excess air ratio of the air-fuel mixture; and a control device. The control device is constructed to control: switching of a combustion capacity between at least two stages of a large-capacity stage and a small-capacity stage through changes in opening degree of the butterfly valve and of the variable throttle valve; and also regulation of the opening degree of the variable throttle valve so that the excess air ratio of the air-fuel mixture as detected by the excess air ratio detecting device becomes a predetermined value. In a state in which the combustion capacity is switched to a small capacity by making the opening degree of the butterfly valve to a predetermined closing-side small-capacity opening degree and also by making the opening degree of the variable throttle valve to a predetermined small-capacity opening degree, if the opening degree of the variable throttle valve changes more to the small-opening-degree side than the predetermined small-capacity opening degree when the excess air ratio of the air-fuel mixture as detected by the excess air ratio detecting device is regulated to become the predetermined value, the control device: regulates the opening degree of the butterfly valve, in a state of returning the opening degree of the variable throttle valve to the predetermined small-capacity opening degree, such that the excess air ratio of the air-fuel mixture as detected by the excess-air ratio detecting device becomes the predetermined value; and performs a small-capacity opening degree renewal control in which the small-capacity opening degree of the butterfly valve is renewed to an opening degree at a time when the excess air ratio has become the predetermined value.

According to this invention, due to the adhesion and deposition of foreign matters on the wall surface of the portion, in which the butterfly valve is disposed, of the air supply passage, even if the opening degree of the variable throttle valve when regulated so that the excess air ratio of the air-fuel mixture at the small-capacity time changes more to the small-opening-degree side than the predetermined small-capacity opening degree, the above-mentioned small-capacity opening degree renewal control can be performed. Then, the characteristic line of fan rotational speed—combustion amount at the small capacity time can be maintained as it was originally the case. As a result, the range in combustion amount that can be obtained in the small capacity and the range of combustion amount that can be obtained in the large capacity are prevented from ceasing to overlap with each other.

By the way, due to such causes as variations in the calorific value of the fuel gas and clogging of an exhaust tube, and the like that are other than the clogging of foreign matters to the wall surface of the air supply passage, there are cases where, at the small-capacity time, the opening degree of the variable throttle valve when regulated so that the excess air ratio of the air-fuel mixture becomes the predetermined value, changes more to the small-opening-degree side than the predetermined small-capacity opening degree. In such a case, it is meaningless to renew the small-capacity opening degree by means of the small-capacity opening degree renewal control. In other words, in case there are causes such as variation in calorific value of the fuel gas, clogging of the exhaust tube, and the like that are other than the adhesion and clogging of foreign maters to the wall surface of the air supply passage, the following may happen. Namely, even in a state in which the opening degree of the butterfly valve is made to be a predetermined opening-side large-capacity opening degree and, at the same time, in a state in which the opening degree of the variable throttle valve is made to be a predetermined large-capacity opening degree so as to switch the combustion capacity to the large capacity, the opening degree of the variable throttle valve when regulated such that the excess air ratio of the air-fuel mixture, as detected by the excess air ratio detecting device, changes more to the small-opening degree side than the predetermined large-capacity opening degree, whereby the fan rotational speed—combustion amount characteristic line at the large-capacity time changes to the low-combustion amount side. As a result, even if the fan rotational speed—combustion amount characteristic line at the small-capacity time is not maintained as it was originally the case by the renewal of the small-capacity opening degree, there will be no possibility that the range of combustion amount obtainable in the small capacity and the range of combustion amount obtainable in the large capacity cease to overlap with each other.

Therefore, in this invention, in a state in which the combustion capacity has been switched to a large capacity as described above, if the opening degree of the variable throttle valve when regulated such that the excess air ratio of the air-fuel mixture as detected by the excess air ratio detecting device changes more to the small-opening-degree side than the predetermined large-capacity opening degree of the variable throttle valve, preferably the control is performed to nullify the renewal of the small-capacity opening degree of the butterfly valve according to the small-capacity opening degree renewal control that was performed previously. Otherwise, in a state in which the combustion capacity is switched to the large capacity as described above, only if the opening degree of the variable throttle valve when regulated such that the excess air ratio of the air-fuel mixture as detected by the excess air ratio detecting device is equivalent to the predetermined large-capacity opening degree, preferably renewal control of the small-capacity opening degree is performed. According to the above-mentioned arrangement, meaningless renewal of the small-capacity opening degree can be evaded when the causes of fluctuation in the calorific value of the fuel gas, the clogging of the exhaust tube and the like that are other than the adhering and clogging of the foreign matters to the wall surfaces of the air supply passage.

Further, in this invention, preferably, the ignition of the burner is performed in a state in which the combustion capacity has been switched to the small capacity and, at the time of ignition, the small-capacity opening degree renewal control is performed. According to this arrangement, the frequency of performing the small-capacity opening degree renewal control becomes high. As a result, the period can be shortened in which the range of combustion amount obtainable in the small capacity and the range of combustion amount obtainable in the large capacity ceases to overlap with each other.

### BRIEF DESCRIPTION OF THE DRAWINGS

FIG. 1 is an explanation diagram showing the premixing apparatus according to an embodiment of this invention.

FIG. 2 is a sectional view taken along the line II-II in FIG. 1.

FIG. 3 is a sectional view taken along the line III-III in FIG. 1.

FIG. 4 is an exploded perspective view of an essential part of a variable throttle valve to be disposed in the premixing apparatus of the embodiment.

FIG. 5 is an exploded perspective view of an essential part of a butterfly valve to be disposed in the premixing apparatus of the embodiment.

FIG. 6 is a graph showing the relationship between the fan rotational speed and the combustion amount in the premixing apparatus of the embodiment.

FIG. 7 is a flow diagram showing the contents of the control by the control device in the premixing apparatus of the embodiment.

FIG. 8 is a flow diagram showing the contents of small-capacity opening degree renewal control to be included in the control contents in FIG. 7.

### MODES FOR CARRYING OUT THE INVENTION

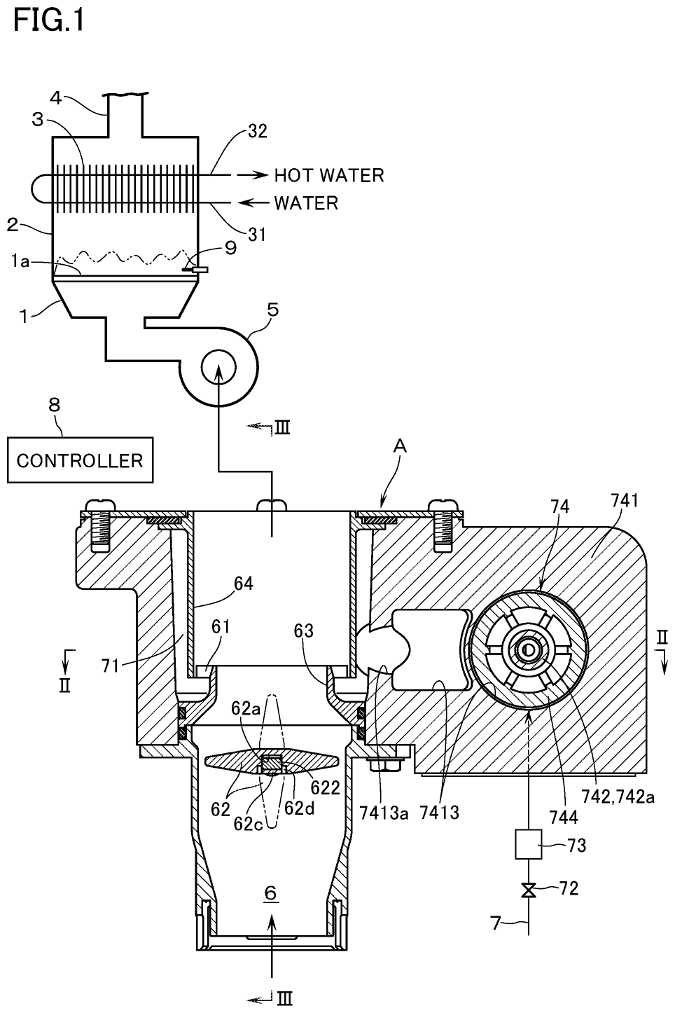

The combustion apparatus represented in FIG. 1 is a heat source apparatus comprising: a totally aerated combustion burner 1; a combustion box 2 enclosing a combustion space of an air-fuel mixture to be ejected from a combustion surface 1a of the burner 1; and a heat exchanger 3 disposed inside the combustion box 2. The heat exchanger 3 has connected thereto a water supply pipe 31 on an upstream side, and a hot water delivery pipe 32 on a downstream side. The combustion gas generated by the combustion of the air-fuel mixture is exhausted outside, after having heated the heat exchanger 3, through an exhaust tube 4 that is connected to an end part of the combustion box 2. By means of a premixing apparatus A according to an embodiment of this invention, air is mixed with a fuel gas, and the resultant air-fuel mixture is supplied to the burner 1 through a fan 5.

The premixing apparatus A is provided with: an air supply passage 6 on the upstream side of the fan 5; a gas supply passage 7 for supplying the fuel gas; and a controller 8 which is a control means or control device. The downstream end of the gas supply passage 7 is connected to a gas suction part 61 which is disposed in the air supply passage 6. In a portion, adjacent to the upstream side of the gas suction part 61, of the air supply passage 6, there is disposed a venturi part 63 of a smaller diameter than the portion in which a butterfly valve 62 is disposed. The butterfly valve 62 will be described in detail hereinafter. The portion, adjacent to the downstream side of the venturi part 63, of the air supply passage 6 is enclosed by a tubular part 64 which is larger in diameter than the venturi part 63. The downstream end of the venturi part 63 is then inserted, while leaving an annular clearance, into the upstream end of the tubular part 64. This clearance constitutes a gas suction part 61. The downstream end of the gas supply passage 7 is provided with a gas chamber 71 which is in communication with the gas suction part 61 in a manner to enclose the tubular part 64. In addition, the gas supply passage 7 has interposed therein, from the upstream side downward in sequence, a main valve 72, a zero governor 73 which adjusts the secondary gas pressure to atmospheric pressure, and a variable throttle valve 74.

The amount of the fuel gas to be supplied through the gas suction part 61 varies with a differential pressure between the atmospheric pressure that is the secondary gas pressure and the negative pressure in the air supply passage 6. It is to be noted here that the negative pressure in the air supply passage 6 varies with the rotational speed of the fan 5. Therefore, the supply amount of the fuel gas varies in proportion to the rotational speed of the fan 5, i.e., in proportion to the supply amount of air. Further, the ratio of the supply amount of the fuel gas to the supply amount of air varies with the opening degree of the variable throttle valve 74. By making the opening degree of the variable throttle valve 74 to a predetermined reference opening degree according to the kind of gas to be used, the excess air ratio of the air-fuel mixture will become an appropriate value (e.g., 1.3). Then, by controlling the rotational speed of the fan 5 according to the required combustion amount (the amount of combustion required to supply hot water at a set hot water temperature), the air-fuel mixture can be supplied to the burner 1 in an amount according to the required combustion amount at the appropriate value of excess air ratio.

By the way, in order to prevent poor exhausting due to entry of the wind into the exhaust tube 4, i.e., in order to secure the wind resistance performance, the lower-limit rotational speed of the fan 5 cannot be set to a considerably lower value. In addition, in case the required combustion amount has fallen below the predetermined value corresponding to the lower-limit rotational speed of the fan 5, the air corresponding to the required combustion amount can no longer be supplied.

As a solution, in a portion, on an upstream side of the gas suction part 61, of the air supply passage 6, there is disposed a butterfly valve 62 that can be switched (or changed) between a closed posture as illustrated in solid lines in FIG. 1 and an open posture as illustrated in imaginary lines in order to switch the flow resistance at the portion in question between two stages of large one and small one. In this arrangement, in case the required combustion amount has fallen below the above-mentioned predetermined value, the butterfly valve 62 is switched to the closed posture to thereby increase the flow resistance in the air supply passage 6. According to this operation, it is possible to supply air in an amount corresponding to the predetermined required combustion amount below the required amount without making the rotational speed of the fan 5 below the lower-limit rotational speed.

It is to be noted that, by simply making the butterfly valve 62 to the closed posture to thereby increase the flow resistance in the air supply passage 6, the negative pressure inside the air supply passage 6 will increase and the supply amount of the fuel gas will become excessive. Therefore, the excess air ratio of the air-fuel mixture to be supplied to the burner 1 will fall below the appropriate value. As a solution, in case the required combustion amount is relatively small, the opening degree of the butterfly valve 62 is changed to a predetermined small-capacity opening degree that is the opening degree at the time of the closed posture and, at the same time, the opening degree of the variable throttle valve 74 is changed to a predetermined small-capacity opening degree that is smaller than the predetermined reference opening degree. According to these operations, the combustion capacity is changed to the small capacity so that the air-fuel mixture can thus be supplied to the burner 1 in an amount corresponding to a relatively small required combustion amount having the appropriate value in the excess air ratio. In case the required combustion amount is relatively large, the opening degree of the butterfly valve 62 is changed to a predetermined large-capacity opening degree that is the opening degree of the butterfly valve 62 in the open posture and, at the same time, the opening degree of the variable throttle valve 74 is changed to a large-capacity opening degree that is the reference opening degree. According to the above operations, the combustion capacity is switched to the large capacity, and the air-fuel mixture whose excess air ratio is the appropriate value and that corresponds to a relatively large required combustion amount can be supplied to the burner 1.

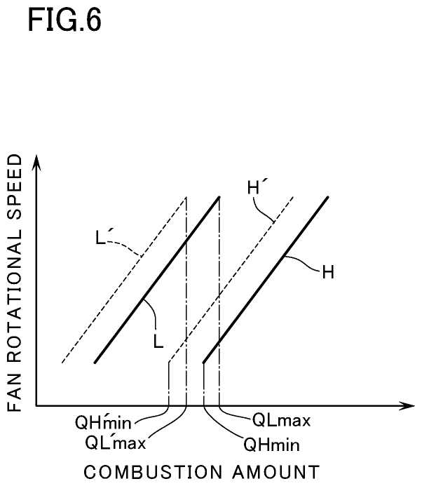

As a result, the relationship between the rotational speed of the fan 5 and the supply amount of air fuel mixture, i.e., the combustion amount of the burner 1 will be as shown by the characteristic line L in FIG. 6 in the small capacity and will be as shown by the characteristic line H in FIG. 6 in the large capacity. The maximum combustion amount QLmax in the small capacity is set to be slightly larger than the minimum combustion amount QHmin in the large capacity. Therefore, the range of combustion amount obtainable in the small capacity and the range of combustion amount obtainable in the large capacity will be partly overlapped with each other. The controller 8 switches the combustion capacity to the large capacity when the required combustion amount has exceeded the maximum combustion amount QLmax in the small capacity, and switches the combustion capacity to the small capacity when the required combustion amount has fallen below the minimum combustion amount QHmin in the large capacity.

By the way, even if the same kind of gas is being used as the fuel gas, there are cases where the calorific values (Wobbe Index) may fluctuate with the time of the day. In this case, when the ratio of the supply amount of the fuel gas to the supply amount of air is constant, the excess air ratio of the air-fuel mixture will fluctuate due to the fluctuation in the calorific value of the fuel gas, thereby resulting in poor combustion.

As a solution, there is provided an excess air ratio detecting device (or detecting means) 9 for detecting the excess air ratio of the air-fuel mixture. In this embodiment, a flame rod provided in a manner to face the combustion surface 1a of the burner 1 constitutes the excess air ratio detecting device 9. In other words, the excess air ratio of the air-fuel mixture is detected by the flame current that flows through the flame rod. By the way, since the flame moves toward or away from the combustion surface la depending on the excess air ratio of the air-fuel mixture, the rear-surface temperature of the combustion surface la varies with the excess air ratio of the air-fuel mixture. Therefore, it is also possible to constitute the excess air ratio detecting device 9 by a temperature sensor for detecting the rear-surface temperature of the combustion surface 1a.

The controller 8 performs a feed-back control in which the opening degree of the variable throttle valve 74 is regulated so that the excess air ratio of the air-fuel mixture as detected by the excess air ratio detecting device 9 becomes constant, i.e., so that the excess air ratio can be maintained at a predetermined appropriate value. In concrete, when the excess air ratio of the air-fuel mixture is reduced by an increase in the calorific value of the fuel gas, the opening degree of the variable throttle valve 74 is reduced so that the ratio of supply amount of the fuel gas to the supply amount of the air is reduced to attain the appropriate value. On the other hand, when the excess air ratio of the air-fuel mixture is increased by a decrease in the calorific value of the fuel gas, the opening degree of the variable throttle valve 74 is increased so that the ratio of supply amount of the fuel gas to the supply amount of the air is increased to attain the appropriate value. According to these operations, even if the calorific value of the fuel gas fluctuates, the excess air ratio of the air-fuel mixture can be maintained at the appropriate value, thereby preventing the poor combustion from occurring.

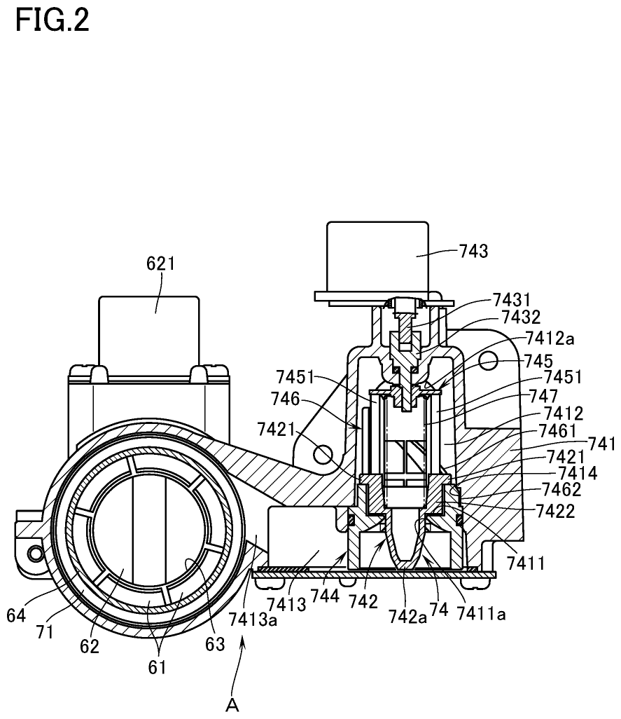

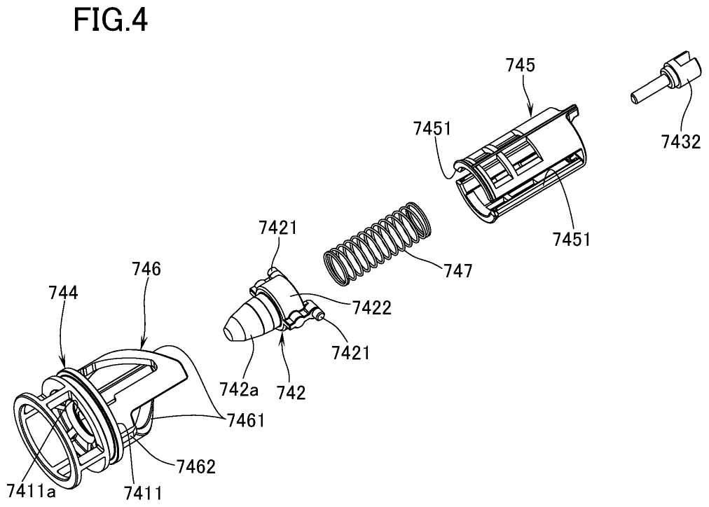

Next, a description will be made of the construction of the variable throttle valve 74 and the butterfly valve 62. With reference also to FIGS. 2 and 4, the variable throttle valve 74 is of an electrically operated type and is made up of a valve body 742 which is axially moveable toward or away from a valve seat 7411 in a valve box 741; a motor 743; and a motion converting mechanism which moves the valve body 742 axially by the rotation of the motor 743. Inside the valve box 741 there are provided a primary gas chamber 7412 having a gas inlet 7412a; and a secondary gas chamber 7413 having a gas outlet 7413a which is in communication with the gas chamber 71. The secondary gas chamber 7413 has mounted therein a member 744 in which is formed a valve seat 7411 for partitioning the primary gas chamber 7412 and the secondary gas chamber 7413.

The motion converting mechanism is made up of: cam pins 7421 which are fixed to the valve body 742; a guide tube 745 having formed therein axially elongated grooves 7451 with which the cam pins 7421 are brought into slidable engagement; and a cylindrical cam body 746 having a spiral cam part 7461 with which the cam pins 7421 get engaged through the elongated grooves 7451. And a non-circular cross-sectional shaft part of a coupling element 7432 to be connected to an output shaft 7431 of the motor 743 is fitted to an end part of the guide tube 745 so that the guide tube 745 can be rotated by the rotation of the motor 743.

In addition, the valve body 742 has: a needle part 742a insertable into a valve hole 7411a formed in the valve seat 7411; and a cylindrical part 7422 inserted into the guide tube 745. At an end part of this tube part 7422, the cam pins 7421 are disposed in a manner to protrude radially outward. Further, a base part of the cam pins 7421 are slidably engaged with the elongated grooves 7451. Therefore, the valve body 742 is coupled to the guide tube 745 in a manner to be axially movable relative to the guide tube 745 and is also rotatable together.

The cam body 746 is prevented from rotating relative to the valve box 741. In concrete, by engaging ribs 7462, disposed in a projecting manner on the peripheral surface of the cam body 746, with grooves 7414 formed on the inner periphery of the valve box 741, the cam body 746 is prevented from rotating relative to the valve box 741. Further, in order to reduce the number of parts, the cam body 746 is formed integrally with the member 744 having formed the valve seat 7411. The cam part 7461 disposed in the cam body 746 are constituted by spiral inclined sides that can be brought into contact with the cam pins 7421. There is also disposed a spring member 747 which urges the cam pins 7421 toward the cam part 7461. Then, by the rotation of the motor 743 in the forward or reverse direction of rotation, the cam pins 7421 will be moved in axially one direction or in the opposite direction while it is rotated and guided by the cam part 7461. According to the above-mentioned arrangements, the valve body 742 will be moved in the closing direction in which the valve body 742 approaches the valve seat 7411 or in the open direction in which the valve body 742 goes away from the valve seat 7411.

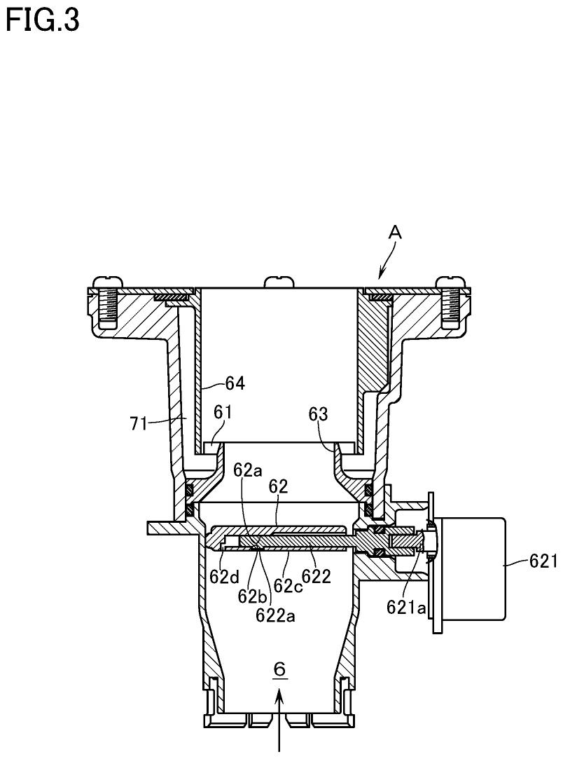

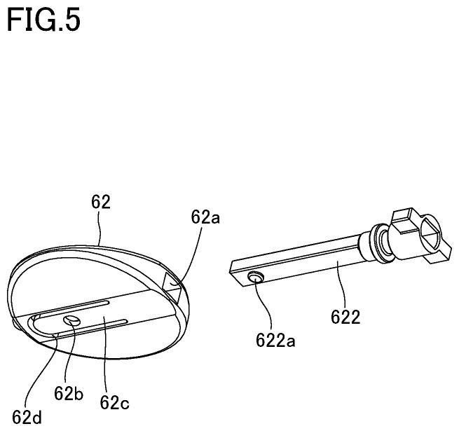

With reference also to FIGS. 3 and 5, the butterfly valve 62 is of a disc shape having a smaller diameter than the inner diameter of a portion, having mounted thereon the butterfly valve 62, of the air supply passage 6, and is driven for rotation by the motor 621 between the closed posture and the open posture. In concrete, the butterfly valve 62 has formed therein an axial hole 62a which is square in cross section and is elongated along an axial line of rotation. Then, into this axial hole 62a there is inserted a valve shaft 622 which is square in cross section and is connected to an output shaft 621a of the motor 621. The butterfly valve 62 is thus connected to the motor 621.

By the way, it may also be considered to fix the butterfly valve 62 to the valve shaft 622 with machine screws, thereby preventing the butterfly valve 62 from getting pulled out of position relative to the valve shaft 622. However, in a region near the sea shore where damages by salt attack are likely to happen, the machine screws are likely to get corroded. As a solution, according to this embodiment, the butterfly valve 62 has formed therein an engaging hole 62b which perpendicularly crosses the shaft hole 62a. Then, a projected part 622a protruded on the outside surface of the valve shaft 622 gets fitted with the engaging hole 62b so that the butterfly valve 62 is prevented from getting pulled out of the valve shaft 622. Further, in a circumference of a portion 62c of a predetermined range of the butterfly valve 62 inclusive of a section in which the engaging hole 62b is formed, by forming a notch 62d except at one end part of the section, the predetermined range of portion 62c is arranged to be elastically deformable. According to this arrangement, at the time of inserting the valve shaft 622 into the shaft hole 62a, the predetermined range of portion 62c is pushed by the projected part 622a so as to be deflected. When the projected part 622a has reached the position in which the projected part 622a coincides with the engaging hole 62b, the projected part 622a gets fitted into the engaging hole 62bby the elastic restoration force of the predetermined range of portion 62c.

By the way, in case foreign matters get deposited on the wall surface of a portion, having disposed therein the butterfly valve 62, of the air supply passage 6 and the amount of adhesion of the foreign matters increases with the lapse of time, there will be little or no influence at the large-capacity time when the opening degree of the butterfly valve 62 is made large. However, at the small-capacity time when the opening degree of the butterfly valve 62 is made small, the amount of air to pass through will decrease and consequently the excess air ratio will decrease. Then, the opening degree of the variable throttle valve 74 is regulated so that the excess air ratio of the air-fuel mixture, as detected by the excess air ratio detecting device 9, becomes the predetermined value. Therefore, when the amount of the air to pass through decreases and the excess air ratio decreases at the small-capacity time, the opening degree of the variable throttle valve 74 after having been regulated will change more to the small-opening-degree side than the predetermined small-capacity opening degree. As a result, the fan revolution—combustion amount characteristic line at the small-capacity time changes to the low-combustion amount side as shown by L′ in FIG. 6. Accordingly, the maximum combustion amount QL′max in the small capacity will become smaller than the minimum combustion amount QHmin in the large capacity. Consequently, the range of combustion amount obtainable in the small capacity and the range of combustion amount obtainable in the large capacity cease to overlap with each other, and it becomes impossible to obtain the combustion amount falling within this non-overlapping range.

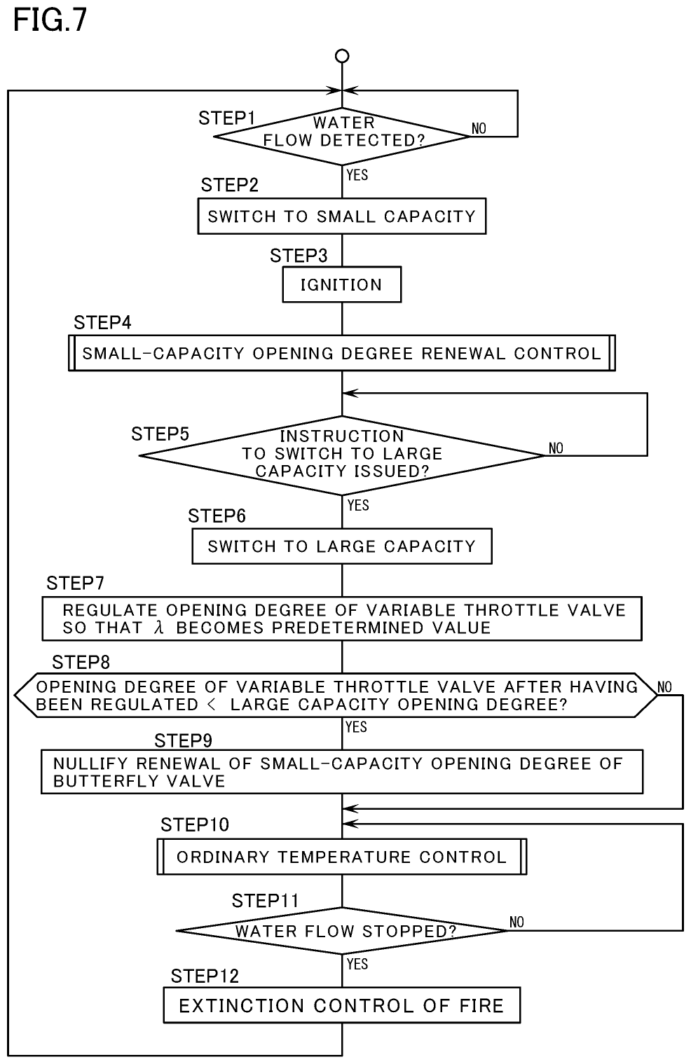

As a solution, the following arrangement as shown in FIG. 7 has been employed in this embodiment. Namely, when a hot water tap (not illustrated) on a downstream end of a hot water supply pipe 32 is opened and the water flow to the heat exchanger 3 is detected by a water sensor (not illustrated) that is interposed in the water supply pipe 31 (STEP 1), by control with the controller 8, the opening degree of the butterfly valve 62 is made to be a predetermined small-capacity opening degree and, at the same time, the opening degree of the variable throttle valve 74 is made to be a predetermined small-capacity opening degree, thereby switching the combustion capacity to the small capacity (STEP 2). In this state, the burner 1 is ignited (STEP 3) and, at the time of this ignition, small-capacity opening degree renewal control is performed (STEP 4).

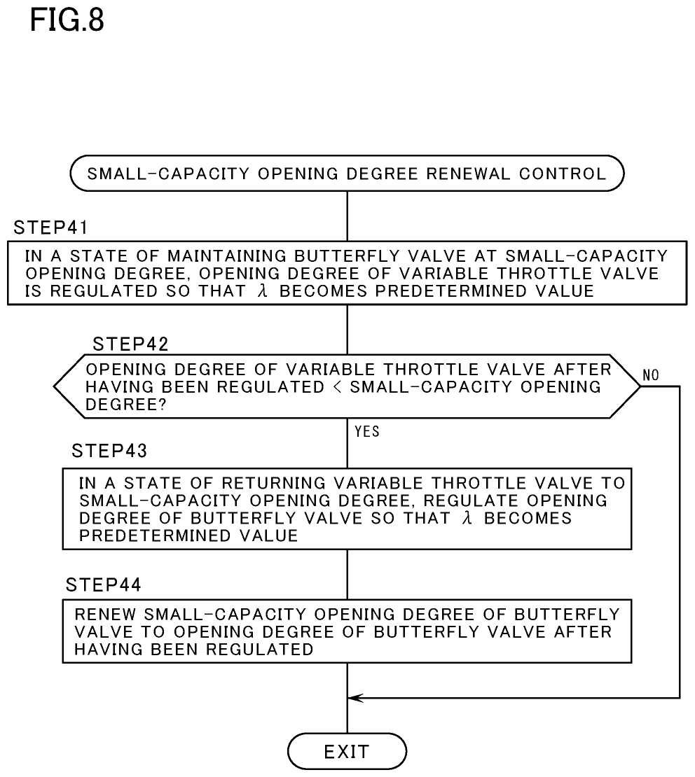

Details of the small-capacity opening degree renewal control are as shown in FIG. 8. First, in a state in which the opening degree of the butterfly valve 62 is maintained at the predetermined small-capacity opening degree, the opening degree of the variable throttle valve 74 is regulated such that the excess air ratio λ of the air-fuel mixture, as detected by the excess air detecting device 9, becomes the predetermined value (STEP 41). Then, a distinction is made as to whether the opening degree of the variable throttle valve 74, after having been regulated, changed more to the small-opening-degree side than the predetermined small-capacity opening degree of the variable throttle valve 74 (STEP 42). Then, if the opening degree has changed to the small-opening-degree side, in a state in which the opening degree of the variable throttle valve 74 is returned back to the predetermined small-capacity opening degree, the opening degree of the butterfly valve 62 is regulated such that the excess air ratio of the air-fuel mixture as detected by the excess air ratio detecting device 9 becomes the predetermined value (STEP 43). The small-capacity opening degree of the butterfly valve 62 is then renewed to the opening degree at the time when the excess air ratio has become the predetermined value (STEP 44).

If the small-capacity opening degree of the butterfly valve 62 is renewed in this manner, there can be evaded a decrease in the amount of air at the small-capacity time due to the adhesion and deposition of foreign matters on the wall surface of the air supply passage. The fan revolution—combustion amount characteristic line at the small-capacity time can be maintained substantially at the same characteristic line as the original curve as shown by the reference mark L in FIG. 6. As a result, the absence of overlapping of the range of combustion amount to be obtained in the small capacity with the range of combustion amount to be obtained in the large capacity can be prevented. In addition, each time of ignition, the small-capacity opening degree renewal control is performed. Therefore, the frequency at which the small-capacity opening degree renewal control is performed becomes high, and the period in which the range of combustion amount at the small capacity and the range of combustion amount at the large capacity cease to overlap with each other can be shortened.

Again with reference to FIG. 7, after having performed the small-capacity opening degree renewal control, distinction is made as to whether an instruction has been issued to switch the combustion capacity to the large capacity because the combustion amount has exceeded the maximum combustion amount QLmax in the small capacity (STEP 5). Then, when the instruction of switching to the large capacity has been issued, the opening degree of the butterfly valve 62 is changed to the predetermined large-capacity opening degree, and also the opening degree of the variable throttle valve 74 is changed to the predetermined large-capacity opening degree so that the combustion capacity can be switched to the large capacity (STEP 6). Subsequently, the opening degree of the variable throttle valve 74 is regulated so that the excess air ratio λ, as detected by the excess air ratio detecting device 9, of the air-fuel mixture becomes the predetermined value (STEP 7). A distinction is then made as to whether the opening degree of the variable throttle valve 74, after having been regulated, changed more to the small-opening-degree side than the predetermine large-capacity opening degree (STEP 8). Then, in case of the change more to the small-opening-degree side, the small-capacity opening degree renewal of the butterfly valve 62 by the small-capacity opening degree renewal control that had previously been made is nullified (STEP 9). Thereafter, an ordinary temperature control inclusive of switching of the combustion capacity to deliver hot water at a set hot temperature is performed (STEP 10). Then, when the water supply has been stopped (STEP 11), fire extinction control of the burner 1 inclusive of closing of the main valve 72, and stopping of the fan 5 is performed (STEP 12).

Due to causes such as fluctuations in the calorific value of the fuel gas, clogging of the exhaust tube 4, and the like other than the adhesion and deposition of foreign matters to the wall surface of the air supply passage 6, at the small-capacity time, there are cases where the opening degree of the variable throttle valve 74 at the time of regulation so as to bring the excess air ratio λ of the air-fuel mixture becomes the predetermined value, may sometimes change more to the small-opening-degree side than the predetermined small-capacity setting opening degree. In this case, even in a state in which the combustion capacity has been switched to the large capacity, the opening degree of the variable throttle valve 74 when regulated such that the excess air ratio λ of the air-fuel mixture becomes the predetermined value, changes more to the small-opening-degree side than the predetermined large-capacity opening degree. Therefore, the fan rotational speed—combustion amount characteristic line at the small-capacity time will change to the low-combustion amount side as shown by L′ in FIG. 6, and also the fan rotational speed—combustion amount characteristic line at the large-capacity time also changes to the low-combustion amount side as shown by H′ in FIG. 6, whereby the minimum combustion amount QH′min at the large capacity becomes smaller than the maximum combustion amount QL′max at the small capacity. As a result, the range of combustion amount obtainable at the small capacity and the range of combustion amount obtainable at the large capacity overlap with each other. Therefore, in case there are causes such as fluctuations in the calorific value of the fuel gas, blocking of the exhaust tube 4, and the like that are other than adhesion and deposition of foreign matters on the wall surface of the air supply passage 6, it is meaningless to renew the small-capacity opening degree of the butterfly valve 62 by the small-capacity opening degree renewal control. In such a case, according to this embodiment, in STEP 9 as shown in FIG. 7, the renewal of the small-capacity opening degree renewal control of the butterfly valve 62 by the previously performed small-capacity opening degree renewal control is nullified. Therefore, meaningless renewal of small-capacity opening degree can be evaded.

By the way, at the time of ignition, the following arrangement may be made. Namely, without performing the small-capacity opening degree renewal control, in a state in which the combustion capacity has been switched to a large capacity after ignition, only in case the opening degree of the variable throttle valve 74 is equivalent to the predetermined large-capacity opening degree when regulated such that the excess air ratio λ to be detected by the excess air ratio detecting device 9 becomes the predetermined value, is equivalent to the predetermined large-capacity opening degree, the small-capacity opening degree renewal control may be performed when the combustion capacity has thereafter been switched to the small capacity. In this case, too, there can be evaded the meaningless renewal of the small-capacity opening degree in case the causes lie in the fluctuations in the calorific value of the fuel gas, clogging of the exhaust tube 4, and the like other than the adhesion and deposition of foreign matters to the wall surface of air supply passage 6.

Descriptions have so far been made of an embodiment of this invention with reference to the drawings. This invention, however, shall not be limited thereto. For example, in the above-mentioned embodiment, an arrangement is made to switch the combustion capacity in two-stage changes in opening degree of the butterfly valve 62. It is, however, possible to arrange the combustion capacity in three stages or more by the variation of opening degree of the butterfly valve 62 in three stages or more.

### EXPLANATION OF REFERENCE CHARACTERS

A premixing apparatus

1 burner

5 fan

6 air supply passage

61 gas suction part

62 butterfly valve

7 gas supply passage

73 zero governor

74 variable throttle valve

8 controller (control device)

9 excess air ratio detecting device

1. A premixing apparatus for mixing air with a fuel gas to supply a burner with an air-fuel mixture through a fan, including:
a zero governor for regulating a secondary gas pressure to an atmospheric pressure, the zero governor being interposed in a gas supply passage whose downstream end is connected to a gas suction part disposed in an air supply passage on an upstream side of the fan; a variable throttle valve interposed in a portion, on a downstream side of the zero governor, of the gas supply passage; a butterfly valve interposed in a portion, on an upstream side of the gas suction part, of the air supply passage; an excess air ratio detecting device for detecting an excess air ratio of the air-fuel mixture; and a control device,
the control device being constructed to control: switching of a combustion capacity between at least two stages of a large-capacity stage and a small-capacity stage through changes in opening degree of the butterfly valve and of the variable throttle valve; and also regulation of the opening degree of the variable throttle valve so that the excess air ratio of the air-fuel mixture as detected by the excess air ratio detecting device becomes a predetermined value,
wherein, in a state in which the combustion capacity is switched to a small capacity by making the opening degree of the butterfly valve to a predetermined closing-side small-capacity opening degree and also by making the opening degree of the variable throttle valve to a predetermined small-capacity opening degree, if the opening degree of the variable throttle valve changes more to the small-opening-degree side than the predetermined small-capacity opening degree when the excess air ratio of the air-fuel mixture as detected by the excess air ratio detecting device is regulated to become the predetermined value, the control device: regulates the opening degree of the butterfly valve, in a state of returning the opening degree of the variable throttle valve to the predetermined small-capacity opening degree, such that the excess air ratio of the air-fuel mixture as detected by the excess-air ratio detecting device becomes the predetermined value; and performs a small-capacity opening degree renewal control in which the small-capacity opening degree of the butterfly valve is renewed to an opening degree at a time when the excess air ratio has become the predetermined value.

2. The premixing apparatus according to claim 1, wherein in a state in which the opening degree of the butterfly valve is made to a predetermined open-side large-capacity opening degree and also in a state in which the opening degree of the variable throttle valve is made to a predetermined large opening degree, to thereby switch the combustion capacity to a large capacity, if the opening degree of the variable throttle valve when regulated such that the excess air ratio of the air-fuel mixture as detected by the excess air ratio detecting device changes more to the small-opening-degree side than the predetermined large-capacity opening degree, control is performed to nullify the renewal, that was performed earlier, of the small-capacity opening degree of the butterfly valve according to the small-capacity opening degree renewal control.

3. The premixing apparatus according to claim 1, wherein in a state in which the opening degree of the butterfly valve is made to a predetermined open-side large-capacity opening degree and also in a state in which the opening degree of the variable throttle valve is made to a predetermined large opening degree, to thereby switch the combustion capacity to a large capacity, only if the opening degree of the variable throttle valve when regulated such that the excess air ratio of the air-fuel mixture as detected by the excess air ratio detecting device is equivalent to the predetermined large-capacity opening degree, the small-capacity opening degree renewal control is performed.

4. The premixing apparatus according to claim 1, wherein the ignition of the burner is performed in a state in which the combustion capacity has been switched to the small capacity and, at the time of ignition, the small-capacity opening degree renewal control is performed.

5. The premixing apparatus according to claim 2, wherein the ignition of the burner is performed in a state in which the combustion capacity has been switched to the small capacity and, at the time of ignition, the small-capacity opening degree renewal control is performed.
